(19) United States
(12) Patent Application Publication
(10) Pub. No.: US 2010/0050807 A1
(43) Pub. Date: Mar. 4, 2010

(54) HAND LEVER FOR VEHICLE

(75) Inventor: Hsieh-Yi TSAI, Taichung County (TW)

Correspondence Address: LADAS & PARRY LLP, 26 WEST 61ST STREET, NEW YORK, NY, 10023, US

(73) Assignee: AUTO-STATE INDUSTRIAL CO., LTD.

(21) Appl. No.: 12/339,122

(22) Filed: Dec. 19, 2008

(30) Foreign Application Priority Data
Sep. 3, 2008 (TW) 097215860

(51) Int. Cl. G05G 1/04

(52) U.S. Cl. 74/502.2

(57) ABSTRACT

A hand lever for a vehicle includes a lever body formed with first and second threaded holes, and a pull lever segment connected pivotally to the lever body and having a stop portion. The first and second threaded holes are located respectively to two opposite sides of the stop portion. A limiting member is threaded within either the first or second threaded holes, and abuts against the stop portion so as to limit the pull lever segment to rotate relative to the lever body in a direction. When the hand lever is disposed at the left side of the vehicle, the limiting member is threaded within the first threaded hole. When the handle lever is disposed at the right side of the vehicle, the limiting member is threaded within the second threaded hole.

### CROSS-REFERENCE TO RELATED APPLICATION

This application claims priority of Taiwanese Application No. 097215860, filed on Sep. 3, 2008.

### BACKGROUND OF THE INVENTION

1. Field of the Invention

This invention relates to a hand lever, and more particularly to a hand lever for operating a clutch or brake of a vehicle, such as a motorcycle.

2. Description of the Related Art

Referring to FIG. 1, a conventional hand lever disclosed in Taiwanese Application No. 94207394 is used for operating a clutch or brake of a motorcycle, and includes a lever body 1, a pull lever segment 2, and a pin 3 extending through the lever body 1 and the pull lever segment 2. The lever body 1 has a groove 101, a pinhole unit 102 in spatial communication with the groove 101, a first flat surface unit 103, and a first curved surface unit 104 connected to and disposed above the first flat surface unit 103. The pull lever segment 2 is a curved rod, and includes a projecting plate 201 inserted into the groove 101 in the lever body 1 and formed with a pinhole 202, a second flat surface unit 203 abutting against the first flat surface unit 103, and a second curved surface unit 304 connected to and disposed above the second flat surface unit 203. The pin 3 is disposed fixedly within the pinhole unit 102 and the pinhole 202. When a direct impact is applied to the free end of the pull lever segment 2 due to contact with the ground surface in the event of a lateral overturning of the motorcycle, the pull lever segment 2 rotates relative to the lever body 1 such that the first and second curved surface units 104, 204 engage slidably each other. Thus, breakage of the hand lever may be avoided.

However, the aforesaid conventional hand lever suffers from the following disadvantages:
(1) The first and second flat surface units 103, 203 and the first and second curved surface units 104, 204 constitute a rotation-limiting mechanism. Since top and bottom half portions of the rotation-limiting mechanism are not symmetrical in structure, the pull lever segment 2 shown in FIG. 1 can be used in the right hand lever but not in the left hand lever.
(2) In a case where the impact on the free end of the pull lever segment 2 is great so that damage is caused to the pull lever segment 2 to an extent that the pull lever segment 2 cannot be used, it is difficult to replace the pull lever segment 2 within a very short period of time, thereby resulting in inconvenience during use.

### SUMMARY OF THE INVENTION

An object of this invention is to provide a hand lever for a vehicle that has a structure, which can be used at either the left or right side of the vehicle.

Another object of this invention is to provide a hand lever that includes a pull lever segment, which can be replaced easily within a very short period of time.

According to this invention, there is provided a hand lever for a vehicle. The handle lever comprises:

a lever body having a pivot portion, the pivot portion having opposite upright front and rear side surfaces, one of which is formed with a pair of adjacent first and second threaded holes, one of the first and second threaded holes being disposed under the other of the first and second threaded holes;

a pivot member;

a pull lever segment aligned with the lever body and having a pivot end connected pivotally to the pivot portion of the lever body by the pivot member, a free end opposite to the pivot end, and a stop portion extending from the pivot end and having opposite first and second sides;

a limiting member threaded within the first threaded hole in the lever body and abutting against the first side of the stop portion of the pull lever segment so as to limit the pull lever segment to rotate relative to the lever body in a direction; and

a positioning unit including a spring-loaded ball disposed on one of the pivot portion of the lever body and the pivot end of the pull lever segment, and a retaining cavity formed in the other of the pivot portion of the lever body and the pivot end of the pull lever segment and engaging the spring-loaded ball so as to prevent rotation of the pull lever segment relative to the lever body;

wherein, when a direct impact resulting from lateral overturning of the vehicle is applied to the free end of the pull lever segment to thereby remove the spring-loaded ball from the retaining cavity, the pull lever segment rotates relative to the lever body in the direction;

wherein, when the limiting member is removed from the first threaded hole and is subsequently threaded within the second threaded hole in the lever body, the limiting member abuts against the second side of the stop portion of the pull lever segment.

Thus, the hand lever can be used at either the left or right side of the vehicle.

Preferably, the pivot member is connected removably to the lever body and the pull lever segment. For example, the pivot member is a bolt. As a consequence, by removing the pivot member, the pull lever segment can be replaced easily within a very short period of time.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is an exploded perspective view of a conventional hand lever disclosed in Taiwanese Application No. 94207394;

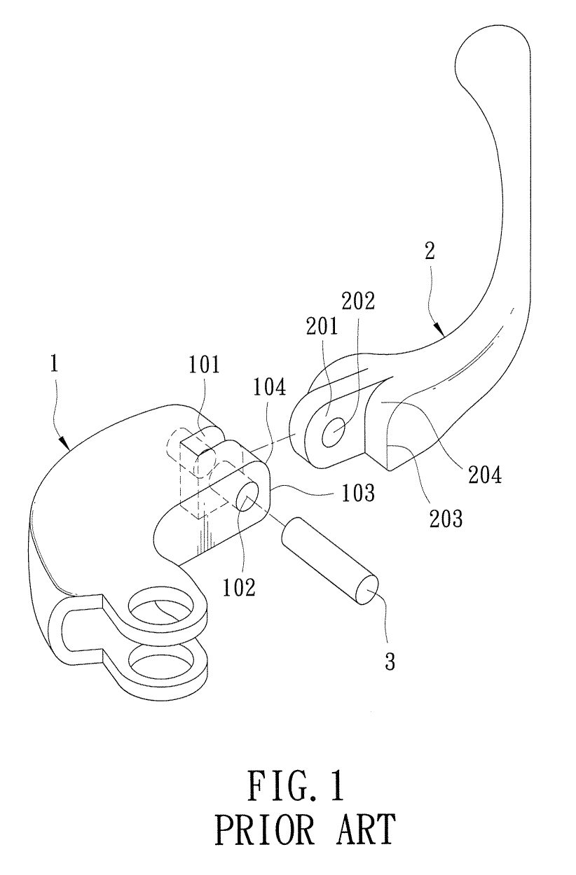

FIG. 2 is a partly exploded perspective view of the preferred embodiment of a hand lever according to this invention;

FIG. 3 is an assembled perspective view of the preferred embodiment in a state of use at the left side of a motorcycle;

FIG. 4 is a fragmentary schematic side view of the preferred embodiment, in a state of use at the left side of the motorcycle and illustrating how a pull lever segment is aligned with a lever body;

FIG. 5 is a view similar to FIG. 4 but illustrating how the pull lever segment is rotated upwardly relative to the lever body due to contact with the ground surface in the event of a lateral overturning of the motorcycle;

FIG. 6 is a view similar to FIG. 3 but in a state of use at the right side of a motorcycle;

FIG. 7 is a fragmentary schematic side view of the preferred embodiment, in a state of use at the right side of the motorcycle and illustrating how the pull lever segment is aligned with the lever body; and

FIG. 8 is a view similar to FIG. 7 but illustrating how the pull lever segment is rotated upwardly relative to the lever body due to contact with the ground surface in the event of a lateral overturning of the motorcycle.

### DETAILED DESCRIPTION OF THE PREFERRED EMBODIMENT

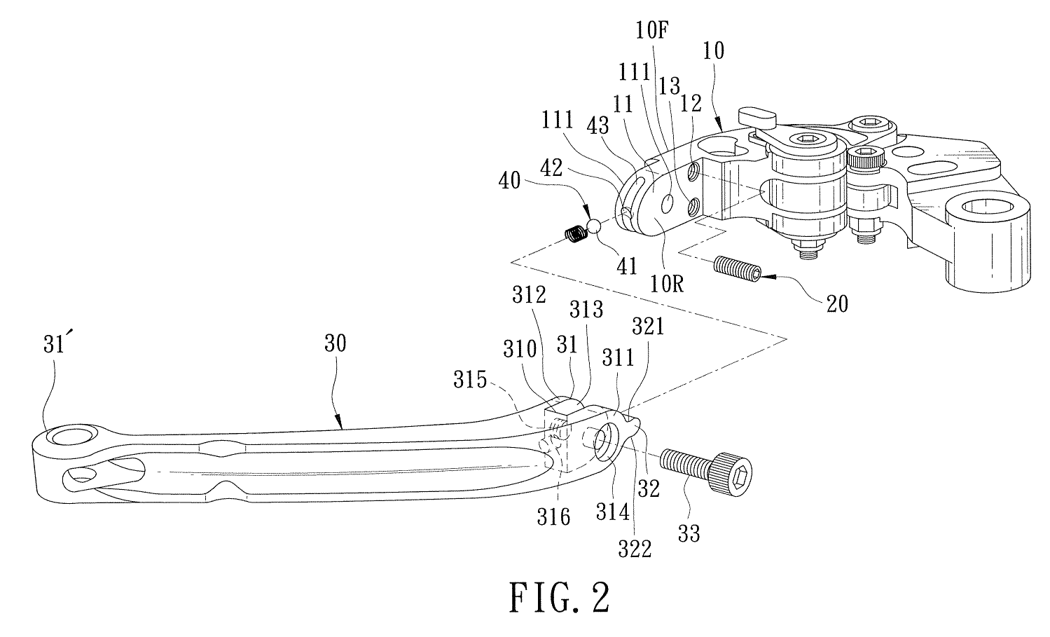

Referring to FIGS. 2, 3, and 4, the preferred embodiment of a hand lever according to this invention is configured as a brake lever of a motorcycle, and may be disposed at the left side of the motorcycle. The handle lever includes a lever body 10, a limiting member 20, a pull lever segment 30, and a positioning unit 40.

The lever body 10 is disposed pivotally on a handgrip (not shown), and has a pivot portion 11 and opposite upright front and rear side surfaces (10F, 10R). The rear side surface (10R) is formed with a pair of adjacent first and second threaded holes 12, 13. The second threaded hole 13 is disposed under the first threaded hole 12.

The pull lever segment 30 is aligned with the lever body 10, and has a pivot end 31 connected pivotally to the pivot portion 11 of the lever body 10 by a pivot member 33, a free end 31′ opposite to the pivot end 31, and a stop portion 32 extending from the pivot end 31 and disposed under the first threaded hole 12 and above the second threaded hole 13 (i.e., the first and second threaded holes 12, 13 are located respectively to two opposite sides of the stop portion 32). The pivot end 31 has a pair of parallel front and rear pivot plates 312, 311 defining a groove 313 therebetween, and a counterbore 314 formed in a rear surface of the rear pivot plate 311, and a threaded hole 315 formed in a rear surface of the front pivot plate 312. The pivot portion 11 of the lever body 10 is disposed pivotally between the pivot plates 311, 312. The groove 313 is further defined by a bottom wall surface 310 connected between the front and rear pivot plates 312, 311. The bottom wall surface 310 is formed with a ball-receiving hole 316. In this embodiment, the stop portion 32 extends from the rear pivot plate 311, and has opposite first and second sides 321, 322. The pivot member 33 is connected removably to the lever body 10 and the pull lever segment 30. In this embodiment, the pivot member 33 is configured as a bolt, extends through the counterbore 314, and engages the threaded hole 315.

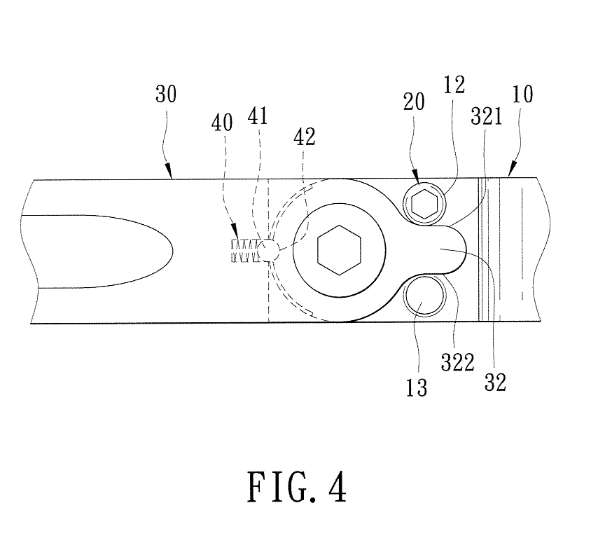

The limiting member 20 is configured as a bolt threaded within the first threaded hole 12 in the lever body 10, and abuts against the first side 321 of the stop portion 32 of the pull lever segment 30, as shown in FIG. 4. As such, the pull lever segment 30 is limited to rotate upwardly relative to the lever body 10.

The positioning unit 40 includes a spring-loaded ball 41 received within the ball-receiving hole 316 in the pivot end 31 of the pull lever segment 30, a retaining cavity 42 formed in a curved end surface 111 of the pivot portion 11 of the lever body 10, and a slide slot 43 formed in the curved end surface 11 and having a middle portion in spatial communication with the retaining cavity 42. The slide slot 43 allows the spring-loaded ball 41 to move therealong, and has a depth smaller than that of the retaining cavity 42. The spring-loaded ball 41 engages the retaining cavity 42 so as to prevent rotation of the pull lever segment 30 relative to the lever body 10. Alternatively, the spring-loaded ball 41 is disposed on the lever body 10, and the retaining cavity 42 is formed in the pull lever segment 30.

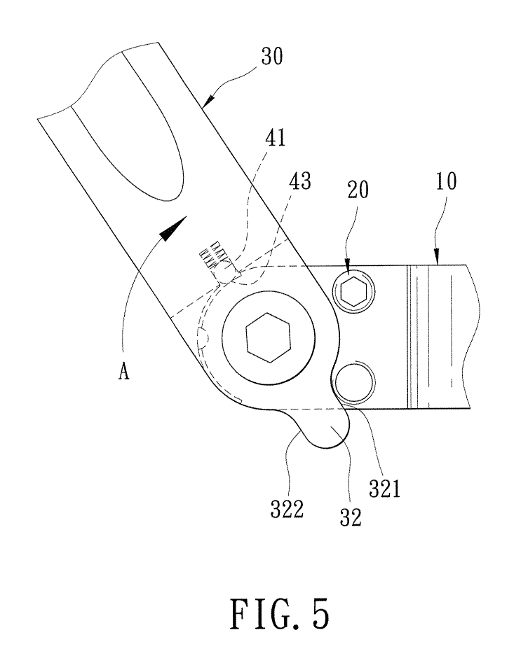

With further reference to FIG. 5, when the free end 31′ of the pull lever segment 30 comes into contact with the ground surface due to lateral overturning of the motorcycle, a direct impact is applied to the free end 31′ of the pull lever segment 30. Hence, the spring-loaded ball 41 is forced to remove from the retaining cavity 42 so that the pull lever segment 30 rotates relative to the lever body 10 in a direction (A). At the same time, the spring-loaded ball 41 moves along the curved slide slot 43. As a result, damage to the hand lever may be avoided.

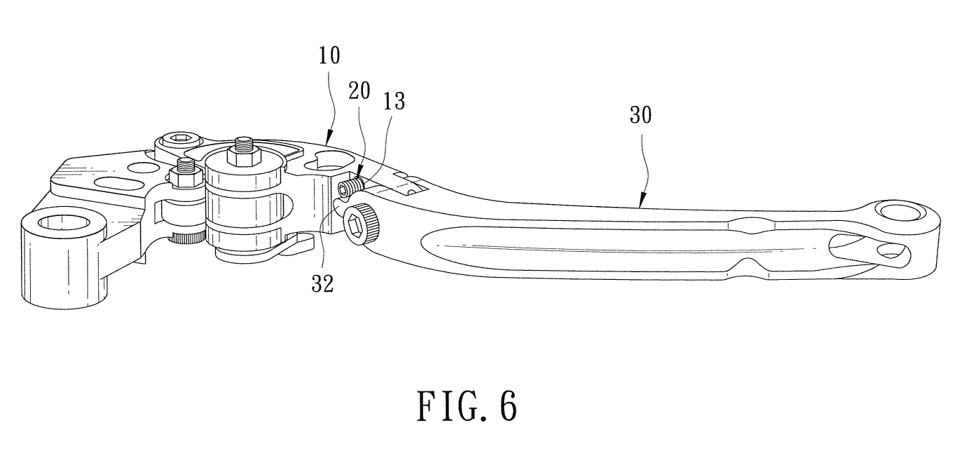

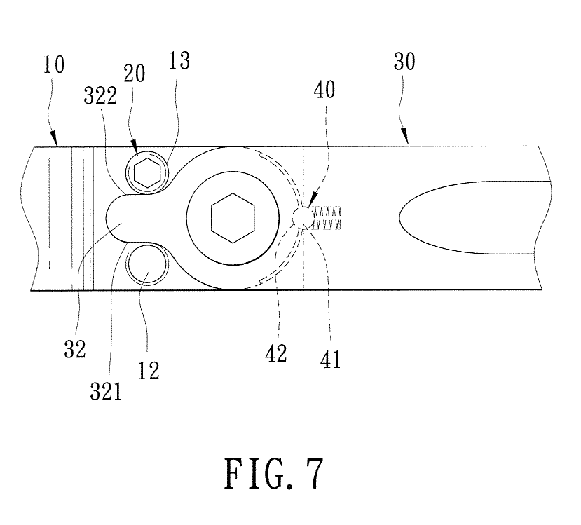

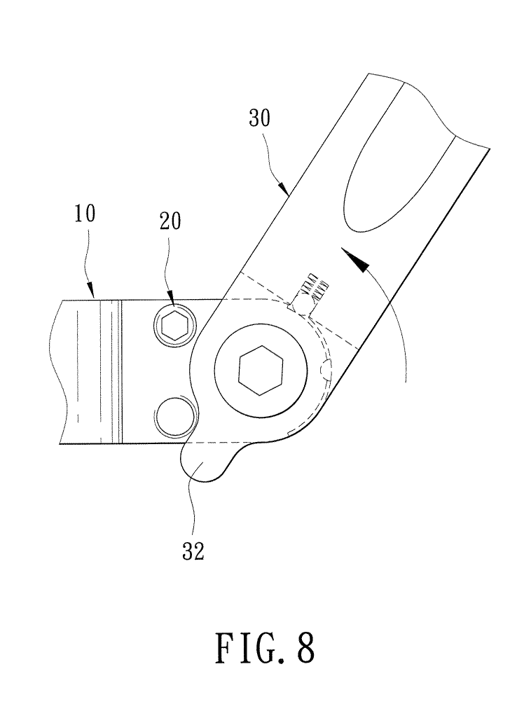

With reference to FIGS. 6 and 7, when the limiting member 20 is removed from the first threaded hole 12 and is subsequently threaded within the second threaded hole 13, and when the hand lever is inverted to exchange the positions of top and bottom sides thereof, the hand lever can be mounted to the right side of the motorcycle to serve as a right brake lever. In this state, the limiting member 20 abuts against the second side 322 of the stop portion 32 to thereby limit the pull lever segment 30 to rotate upwardly relative to the lever body 10 when the spring-loaded ball 41 is removed from the retaining cavity 42, as shown in FIG. 8.

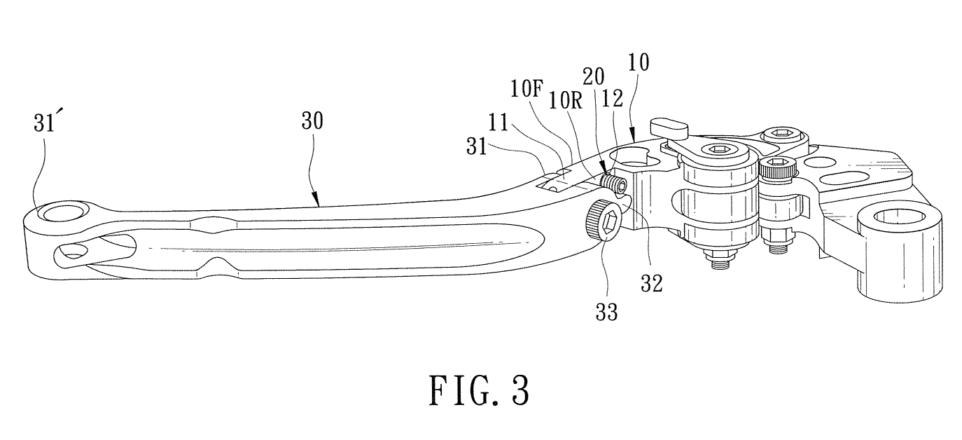

In view of the above, the hand lever of this invention has a plurality of components that can be disposed at the left side of the motorcycle to serve as a left brake lever, as shown in FIG. 3, or at the right side of the motorcycle to serve as a right brake lever, as shown in FIG. 6. Furthermore, when damage is caused to the pull lever segment 30, the pivot member 33 can be removed easily from the lever body 10 and the pull lever segment 30 to thereby allow for replacement of the pull lever segment 30 within a very short period of time. Thus, the objects of this invention are achieved.

With this invention thus explained, it is apparent that numerous modifications and variations can be made without departing from the scope and spirit of this invention. It is therefore intended that this invention be limited only as indicated by the appended claims.

I claim:

1. A hand lever for a vehicle, said handle lever comprising:
a lever body having a pivot portion, said pivot portion having opposite upright front and rear side surfaces, one of which is formed with a pair of adjacent first and second threaded holes, one of said first and second threaded holes being disposed under the other of said first and second threaded holes;
a pull lever segment aligned with said lever body and having a pivot end connected pivotally to said pivot portion of said lever body by said pivot member, a free end opposite to said pivot end, and a stop portion extending from said pivot end and having opposite first and second sides;
a limiting member threaded within said first threaded hole in said lever body and abutting against said first side of said stop portion of said pull lever segment so as to limit said pull lever segment to rotate relative to said lever body in a direction; and
a positioning unit including a spring-loaded ball disposed on one of said pivot portion of said lever body and said pivot end of said pull lever segment, and a retaining cavity formed in the other of said pivot portion of said lever body and said pivot end of said pull lever segment and engaging said spring-loaded ball so as to prevent rotation of said pull lever segment relative to said lever body;
wherein, when a direct impact resulting from lateral overturning of the vehicle is applied to said free end of said pull lever segment to thereby remove said spring-loaded ball from said retaining cavity, said pull lever segment rotates relative to said lever body in the direction;
wherein, when said limiting member is removed from said first threaded hole and is subsequently threaded within said second threaded hole in said lever body, said limiting member abuts against said second side of said stop portion of said pull lever segment.

2. The hand lever as claimed in claim 1, wherein said pivot member is connected removably to said lever body and said pull lever segment.

3. The hand lever as claimed in claim 2, wherein said pivot member is configured as a bolt.

4. The hand lever as claimed in claim 1, wherein said pivot end of said pull lever segment is formed with two parallel pivot plates defining a groove therebetween, said pivot portion of said lever body being disposed pivotally between said pivot plates of said pivot end of said pull lever segment.

5. The hand lever as claimed in claim 4, wherein:
said groove in said pull lever segment is further defined by a bottom wall surface connected between said pivot plates, said bottom wall surface being formed with a ball-receiving hole for receiving said spring-loaded ball therewithin; and
said pivot portion of said lever body has a curved end surface formed with said retaining cavity, said curved end surface being further formed with a curved slide slot in spatial communication with said retaining cavity, said slide slot allowing movement of said ball therealong and having a depth smaller than that of said retaining cavity.
